(19) United States
(12) Patent Application Publication
(10) Pub. No.: US 2006/0242000 A1
(43) Pub. Date: Oct. 26, 2006

(54) System and method for capturing and consolidating leads

(76) Inventor: Gannon K. Giguiere, Newport Coast, CA (US)

Correspondence Address: PETER K HAHN;LUCE, FORWARD, HAMILTON, SCRIPPS, LLP., 600 WEST BROADWAY, SUITE 2600, SAN DIEGO, CA, 92101, US

(21) Appl. No.: 11/109,918

(22) Filed: Apr. 20, 2005

(51) Int. Cl. G06F 17/30

(52) U.S. Cl. 705/10

(57) ABSTRACT

The present invention is directed to a system and method for capturing and consolidating a plurality of leads, each lead comprising a potential consumer customer. The method for capturing and consolidating a plurality of leads includes the steps of sourcing the plurality of leads, capturing consumer data related to the leads, consolidating the leads using a lead generation protocol and verifying the leads telephonically.

### FIELD OF THE INVENTION

The present invention generally relates to systems and methods for generating leads, and more particularly to Internet-based lead generation systems and methods that feature real time telephonic lead verification.

### BACKGROUND OF THE INVENTION

Direct marketing is an efficient method of selling that was introduced in the 1960's to take advantage of developments in automation and the study of advertising. Rather than advertise to the general population, marketing efforts are focused on those most likely to purchase, leading to more cost-effective sales techniques. Based on scientific advertising principles, direct marketing is serviced by increasingly more automated warehousing, shipping, and collection techniques. Lester Wunderman, commonly regarded as the father of the direct marketing field, coined the phrase, “direct marketing”, in 1961.

Direct marketing is only effective when certain conditions are met. A prospect must have the ability, willingness, and readiness to buy before a direct sale can be consummated. Marketers attempt to develop an ideal customer profile and suitable means for communicating with an ideal audience. Those likely to be interested in a given product or service are termed suspects. Suspects that express an interest in the offer (i.e. a willingness to purchase) are known as prospects. Those prospects with the financial ability to purchase are called qualified prospects. Intenders are qualified prospects that are ready to purchase in the near future, and it is from the intenders that customers are finally generated.

Most direct marketing work aims to ascertain the ability of qualified prospects to pay. It is relatively straightforward to use demographic or lifestyle data (e.g., household income) to determine a suspect or prospect's ability to pay. However, such data provides little information on willingness or readiness to purchase. Predictive modeling or surveys of buying intentions have addressed such limitations. Predictive modeling is a statistical technique that uses various attributes about a prospect to assess a likelihood of buying. These attributes include actual or predicted behavior, attitude as determined from surveys, and collected or overlaid demographic data. Those believed to be unlikely buyers are excluded from costly direct marketing programs, while the most likely buyers are the subjects of intense marketing efforts. Predictive modeling provides the advantages of low cost and scalability.

One disadvantage of predictive models is that they may miss key attributes and incorporate stale data. For example, predictive models are often used for predicting purchases of high-ticket items, such as automobiles. However, the intention to buy a new car is often known only after the fact, when new vehicle registration information is available. What is needed is a reliable leading indicator of buying intent. Surveying has been considered the standard for identifying intender leads-consumers with a stated intention of buying a particular class of product within a given time frame. Surveys include questions that assess buying intentions, for example, “Do you plan to buy a new car in the next six months?” The self-reported data is then used to identify intender leads. A significant problem with surveys is that they are inefficient, as measured by the response rate, and expensive, as measured by the cost per completed survey. Furthermore, a link between a consumer's stated future intention and actual action is somewhat tenuous.

Both predictive models and surveys also suffer from a delay between lead generation and distribution to a sales force for pursuit. Even if the leads are of high quality, by the time that they can be distributed using traditional methods, the leads are no longer “hot,” i.e. the purchase has already been completed.

The current leads aggregation industry consists of various competitive forces including “sourcers”, “providers” and “affiliate networks”. Sourcers typically have strong consumer brands, but limited business-to-business e-commerce engines and affiliate offerings, whereas providers usually have limited consumer brands, but robust business-to-business e-commerce engines. On the other hand, affiliate networks play an intermediary role between a network of online content publishers and both professional service sourcers and professional service providers. While there are identifiable industry leaders in each of the above categories, there are no entities that combine all three approaches to offer the marketplace a comprehensive solution for consumers, professional service providers and affiliate participants.

In view of the above drawbacks, there exists a need for an Internet-based lead generation system and method, wherein generated leads are verified telephonically in real time.

Additionally, there exists a need for a single entity that functions as a sourcer, provider and affiliate network to offer the marketplace a comprehensive solution for consumers, professional service providers and affiliate participants.

There also exists a need for a lead verification system and method that supplies, in real time, professional service providers with the most qualified and targeted consumer audience to market against.

There further exists a need for a lead verification system and method that equips professionals with automated lead flow, lead quantification, online payment tools and back office sales automation/CRM integration.

In addition, there exists a need for a lead verification system and method that includes a stringent lead generation protocol to ensure fraud prevention for all submissions.

There also exists a need for a lead verification system and method that provides technological address data verification and telephonic verification through a call center.

There further exists a need for a lead verification system and method that provides education on how to maximize success rates of consumer transactions from all lead generation methods, thereby allowing the professional service providers to focus on closing more business rather than sourcing more leads.

There additionally exists a need for a lead verification system and method that affords consumers with a comprehensive opportunity to find research and secure meaningful rebates for household and personal related financial commitments.

There also exists a need for a lead verification system that supplies consumers with the best rates for their current situation with respect to household and personal related financial commitments.

There further exists a need for a lead verification system and method that supplies consumers with a personalized and timely outreach marketing experience, demonstrating how one can continue to secure the optimal product, service and rate over time.

In addition, there exists a need for a lead verification system and method that supplies publishers with premium offers allowing for greater conversion of dollars from existing site traffic.

There also exists a need for a lead verification system and method that provides affiliates with automated account management, program optimization, ad-serving/refreshment and online compensation tools.

### SUMMARY OF THE INVENTION

In view of the foregoing, it is an object of the present invention to provide an Internet-based lead generation system and method, wherein generated leads are verified telephonically in real time.

It is an additional object of the present invention to provide a lead generation system and method that functions as a sourcer, provider and affiliate network to offer the marketplace a comprehensive solution for consumers, professional service providers and affiliate participants.

It is another object of the invention to provide a lead verification system and method that supplies professional service providers with the most qualified and targeted consumer audience to market against.

It is a further object of the invention to provide a lead verification system and method that equips professionals with automated lead flow, lead quantification, online payment tools and back office sales automation/CRM integration.

It is an additional object of the invention to maintain a lead verification system and method that includes a stringent lead generation protocol to ensure fraud prevention for all submissions.

It is yet another object of the invention is to provide a lead verification system and method that provides technological consumer data verification and telephonic verification through a call center.

It is another object of the invention to provide a lead verification system and method that provides education on how to maximize success rates of consumer transactions from all lead generation methods, thereby allowing the professional service providers to focus on closing more business rather than sourcing more leads.

It is an additional object of the invention to provide a lead verification system and method that supplies consumers with the best rates for their current situation with respect to household and personal related financial commitments.

It is a further object of the present invention is to provide a lead verification system and method that affords consumers with a comprehensive opportunity to find, research and secure meaningful rebates for household and personal related financial commitments.

It is yet another object of the invention is to provide a lead verification system and method that supplies consumers with a personalized and timely outreach marketing experience, demonstrating how one can continue to secure the optimal product, service and rate over time.

It is another object of the invention is to provide a lead verification system and method that supplies affiliate publishers with premium offers allowing for greater conversion of dollars from existing site traffic.

It is a further object of the invention to provide a lead verification system and method that provides affiliates with automated account management, program optimization, ad-serving/refreshment and online compensation tools.

One aspect of the present invention is directed to a method for capturing and consolidating a plurality of leads, wherein each lead comprises a potential consumer customer. The method includes the steps of sourcing the plurality of leads, capturing consumer data related to the leads, consolidating the leads using a lead generation protocol and verifying the leads telephonically in real time. The step of sourcing the leads may include deploying marketing tactics in the form of advertisements and/or sourcing leads from external sources. The step of consolidating the leads using a lead generation protocol comprises the steps of checking all consumer data for spurious or inconsistent data and purging consumer data that contains spurious or inconsistent data.

Another aspect of the invention,is directed to a system for capturing and consolidating a plurality of leads, wherein each lead comprises a potential consumer customer. The system comprises means for sourcing the plurality of leads, a computer software program comprising machine readable instructions for capturing consumer data related to the plurality of leads and consolidating the leads using a lead generation protocol, and means for verifying the leads telephonically in real time. The means for sourcing the plurality of leads comprises deploying marketing tactics in the form of advertisements. The lead generation protocol is employed to check all consumer data for spurious or inconsistent data.

### BRIEF DESCRIPTION OF THE DRAWINGS

Further features of the invention, its nature and various advantages will be more apparent from the accompanying drawings and the following detailed description of the preferred embodiments, in which:

FIG. 1 depicts a consumer-focused website of the invention comprising a plurality of core consumer applications;

FIG. 2 depicts a professional service provider-focused website of the invention comprising a plurality of core professional service provider applications;

FIG. 3 depicts an affiliate network-focused website of the invention comprising a plurality of core affiliate network applications;

FIG. 4 depicts a system platform of the invention comprising a site management system, a lead management system, an order management system and a customer relationship management system; and

FIG. 5 is a schematic diagram depicting a preferred method of capturing and consolidating a plurality of leads according to the principles of the present invention.

It will be recognized that some or all of the Figures are schematic representations for purposes of illustration and do not necessarily depict the actual relative sizes or locations of the elements shown.

### DETAILED DESCRIPTION OF THE INVENTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

The present invention comprises an information services and direct marketing system for aggregating and leveraging consumer inquiries. The system preferably is implemented as part of a computer system including a software program comprising machine readable or interpretable instructions used to provide an Internet-based lead generation and marketing system. According to a preferred implementation of the invention, leads generated by the system are verified telephonically in real time, thereby providing professional service providers with a highly qualified and targeted consumer audience to market against. The lead verification system equips professional service providers with automated lead flow, lead quantification, online payment tools and back office sales automation/CRM integration.

The Internet-based lead generation and marketing system may be utilized for aggregating and leveraging consumer inquiries in areas including, but not limited to: (1) home financing; (2) auto financing; (3) boat/RV financing; (4) airplane financing; (5) personal credit cards; (5) debt management; (6) credit reporting and monitoring services; (7) personal banking; (8) online bill paying; (9) financial brokerage; (10) real estate services; (11) moving services; (12) storage services; (13) insurance products; and (14) everyday utility services.

The present invention is directed to capturing, consolidating and selling leads to professional service providers, wherein the leads relate to consumers seeking assistance with large one-time transactions, as well as everyday household services. Consumer inquiries may be sourced through affiliate marketing, search engine optimization, online advertising, co-brand syndication, and telephonic outreach and direct mail/email activities. According to a preferred embodiment of the invention, consumer inquiries are stored, sorted and managed through a proprietary information management system, thereby allowing the professional service providers to transact and build lifetime relationships with each consumer.

Advantageously, the lead verification system of the present invention combines the approaches of: (1) conventional sourcers (e.g., www.lendingtree.com, www.monstermoving.com, www.lowermybills.com, etc.); (2) conventional providers (e.g., www.alansis.com, www.leadbot.com, www.ileads.com, etc.); and (3) conventional affiliate networks (e.g., www.cj.com, www.linkshare.com, www.affiliatefuel.com, etc.). By combining the approaches of these entities, a comprehensive solution for consumers, professional service providers and affiliate participants is created. This comprehensive solution preferably includes strong consumer brands and robust business-to-business e-commerce engines, and allows system users to play an intermediary role between a network of online content publishers and professional service sourcers and/or providers.

According to a preferred implementation of the invention, all leads sourced are verified both using the computer system and telephonically in real time, thereby providing professional service providers with a highly qualified and targeted consumer audience to market against. The lead verification system equips professional service providers with automated lead flow, lead quantification, online payment tools and back office sales automation/CRM integration.

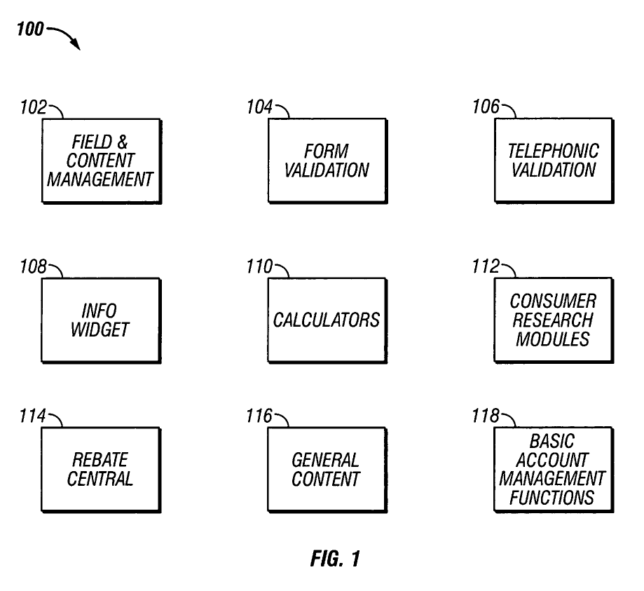

According to the principles of the invention, customers may access the Internet-based lead generation system disclosed herein by visiting one of a plurality of websites, including a consumer-focused website, a website focused on professional service providers and a website focused on affiliate networks. Preferably, the websites are implemented using the software of the present invention. Referring to FIG. 1, consumer-focused website 100 comprises a plurality of core consumer applications including field and content management 102, form validation 104, telephonic validation 106, an informational widget 108, calculators 110, consumer research modules 112, rebate central 114, general content 116 and basic account management functions 118. An example of a consumer-focused website for an Internet-based lead generation system is located at www.getlower.com.

Consumer-focused website 100 is designed to provide consumers with a comprehensive opportunity to comparison shop for lower rates with respect to household and personal related financial commitments, as well as with respect to research and secure meaningful rebates for transacting through a professional service provider. Consumer-focused website 100 also supplies consumers with a personalized and timely outreach marketing experience, and demonstrates how the consumer may continue to secure the optimal product, service and rate over time

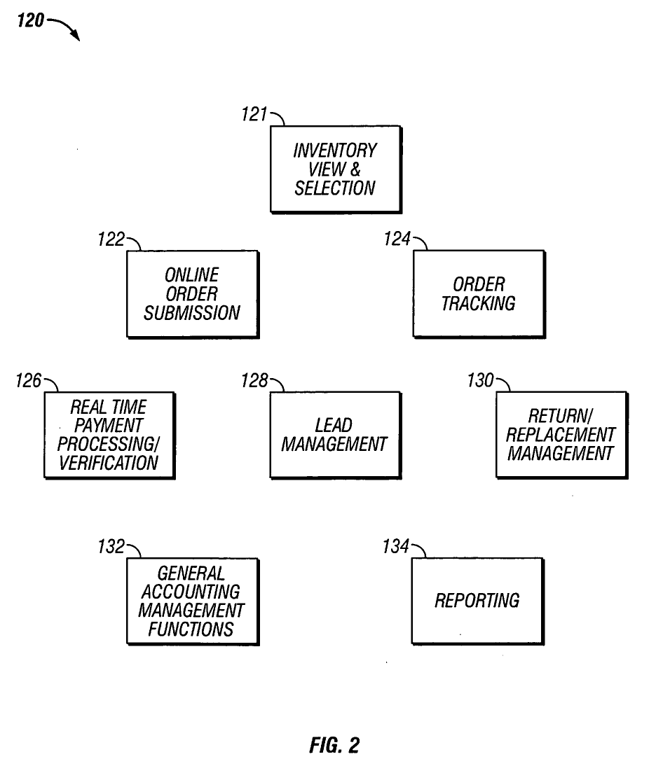

Referring to FIG. 2, professional service provider-focused website 120 comprises a plurality of core professional service provider applications including real time lead inventory view and selection 121, online order submission 122, order tracking 124, real time payment processing and/or payment verification 126, lead management 128, return management and/or replacement management 130, general account management functions 132 and reporting 134. An example of a professional service provider-focused website for an Internet-based lead generation system is located at www.leads.getlower.com. Provider-focused website 120 offers education regarding maximizing success rates of consumer transactions from all lead generation methods. Advantageously, this allows the professional service provider to focus on business matters rather than sourcing leads.

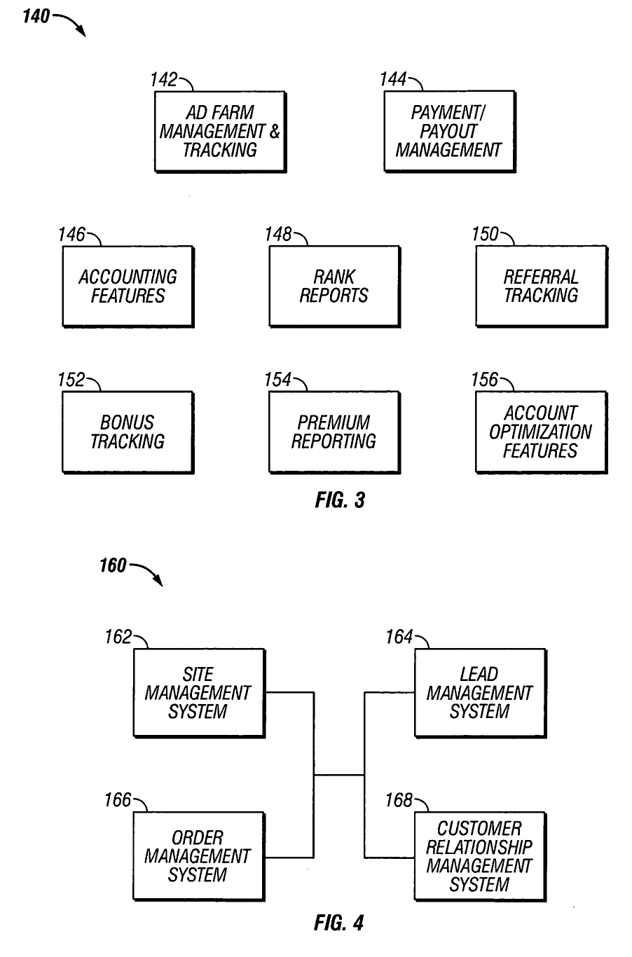

Referring to FIG. 3, affiliate network-focused website 140 comprises a plurality of core affiliate network applications including ad farm management and trafficking 142, payment/payout management 144, accounting features 146 (including 1099 management and check cutting), rank reports 148, referral tracking 150, bonus tracking 152, premium reporting 154 and account optimization features 156. An example of an affiliate network-focused website for an Internet-based lead generation system is located at www.affilates.getlower.com. Additionally, the affiliate-focused website 140 preferably supplies publishers with premium offers allowing for greater conversion of dollars from existing site traffic. Such premium offers may include: (1) bonus programs; (2) referral initiatives; (3) site ranking; (4) loyalty rewards; and (5) other premium offers.

Affiliate-focused website 140 provides affiliates with automated account management, program optimization, ad-serving/refreshment and online compensation tools. Particularly, affiliate-focused website 140 provides robust, creative selections and offers in the categories of: (1) coverage; (2) performance statistics that support the selections/offers; and (3) optimization education to ensure maximum conversion success.

Referring to FIG. 4, a system platform 160 is provided to substantially seamlessly coordinate the experience of consumer customers, professional service provider customers and affiliate network customers. Platform 160 comprises a plurality of separate but integrated components including Site Management System 162 (“SMS”), Lead Management System 164 (“LMS”), Order Management System 166 (“OMS”), and Customer Relationship Management System 168 (“CRMS”). Preferably, the SMS 162, LMS 164, OMS 166 and CRMS 168 are implemented using the software of the present invention.

The SMS 162 is a web-based application that allows for multi-tiered user groups to operate all facets of the websites described hereinabove. The SMS platform preferably comprises a robust library that allows for easy storage and access of source files for all site properties and creative units. Additionally, the SMS platform allows live files, including licensed imagery that can be managed online to permit instant network-wide updates. In this manner, the SMS 162 is a self-learning system that facilitates the rapid development and enhancement of technology.

The LMS 164 preferably comprises a web-based data platform for all consumer customer information, professional service provider customer information and affiliate customer information. When accessed online, the LMS 164 can display all available lead information, or queries can be performed for specific criteria needs. The LMS 164 is designed to provide leads that match professional service provider needs. Users such as professional service providers are provided with a window to view lead information in real time. Data preferably may be uploaded or downloaded in multiple formats for ease of integration with new data. For example, the leads may be delivered via e-mail, facsimile, direct mail, or other forms of communication. Additionally, the data may be sent as a .DOC, .CSV, .PDF, .XML or other file type.

The OMS 166 preferably comprises a web-based platform that operates the delivery of data to a sales force (www.salesforce.com) that may include sales managers and account executives. In operation, inventory data is passed real time from the LMS 164 to the OMS 166, thereby allowing access to current availability for the sales managers and account executives. Once an order has been entered (e.g., at www.salesforce.com), the data is passed through the OMS 166, which updates the available inventory status. The OMS 166 is also responsible for processing all payments and refunds in real time, thus insuring that no inventory is locked without approved payment and that all inventory is unlocked with an approved refund.

The CRMS 168 is a web-based application that fulfills corporate wide marketing needs. One aspect of the CRMS 168 involves the cross-promotion of other products. Specifically, the CRMS 168 is used to market other event driven technology to consumers once they are captured. The content of the CRMS 168 varies depending upon whether the user is a consumer customer, professional service provider customer or network affiliate customer.

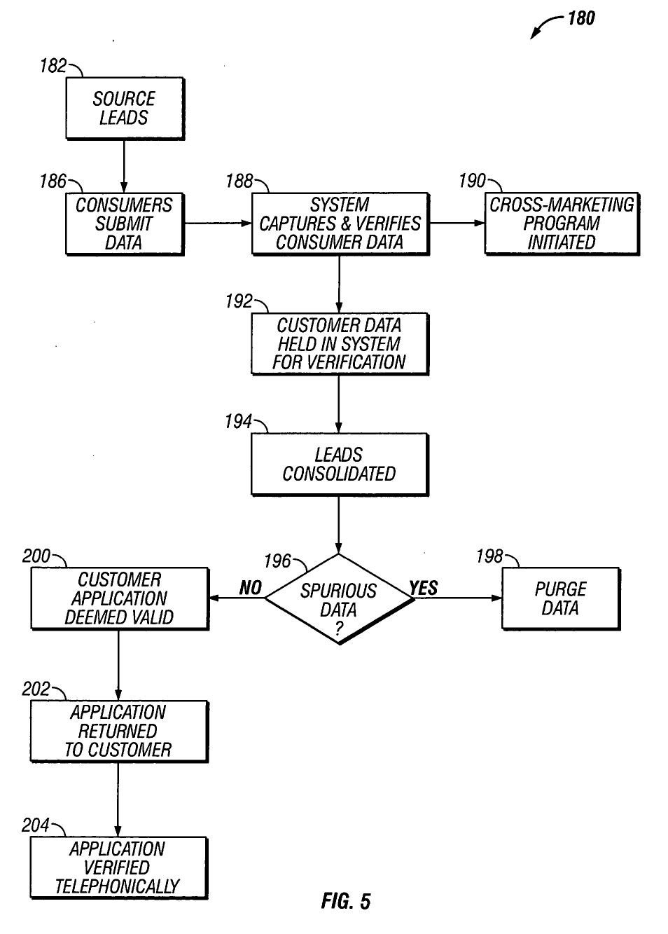

Referring to FIG. 5, a preferred method 180 of capturing and consolidating a plurality of leads according to the principles of the present invention is now described. In step 182, potential consumer customers (leads) are sourced by deploying marketing tactics. These tactics may include Internet generation such as using display graphical ads, text link advertising, e-mail solicitation, affiliate marketing, and search engine optimization techniques. Other forms of advertising may include network television advertising, satellite and cable advertising, radio advertising, direct mail and outdoor advertising. In step 186, potential consumer customers (leads) must submit consumer data after they are sourced, for example by submitting a customer application form that can be accessed using the customer website. The customer application is designed to collect data such as contact information, residence information, income level, lifestyle information and other valuable forms of consumer information.

When a consumer customer submits an application form, consumer data is captured and technologically verified (step 188) by the system of the invention, for the purposes of generating quality leads for professional service providers and providing affiliate marketers an opportunity to generate long-term revenue streams for traffic from their sites. In step 190, a continual outreach and cross-marketing program is initiated to each consumer customer using automated email and/or telephonic techniques. This action-response system advantageously encourages continual communication with all consumer customers. Referring to step 192, consumer customer data is held in the system while the information is verified and the leads are consolidated. For example, the consumer customer data may be held in the LMS 164.

With further reference to FIG. 5, step 194 involves consolidating the leads using a stringent lead generation protocol. In step 196, the lead generation protocol checks all consumer applications for spurious and/or inconsistent data. Specifically, the lead verification protocol may provide technological address data verification and telephonic verification, for example, through a call center. Additionally, the zip code in a consumer application may be matched against the city/state. Referring to step 198, applications containing spurious and/or inconsistent data are deemed invalid and purged from the system. By way of example, applications containing a zip code that does not match the city/state may be deemed invalid. Further, any consumer customer application containing profanity or widely-known slang may be deemed invalid and purged from the system. In step 200, applications that do not contain spurious or inconsistent data are deemed valid. As would be understood to those of ordinary skill in the art, additional measures may be employed to verify consumer applications without departing from the scope of the invention.

In step 202, consumer applications that are deemed valid are returned to the appropriate customers for verification of the data. Referring to step 204, according to an aspect of the invention, all consumer applications are then verified telephonically to further ensure the validity of each application, as well as the efficacy of the lead that the valid application provides. A telephone call is made to each consumer to verify their intent to purchase one or more services. In this manner, leads generated by the system are verified telephonically in real time, thereby providing professional service providers with a highly qualified and targeted consumer audience to market against.

In accordance with another aspect of the present invention, when a professional service provider customer places an order, a programmed continual outreach and cross-marketing program is initiated using automated email. The professional service provider customers are entered into an electronic solicitation program, which drives low-cost repeat business activity, referral activity and ongoing account access.

In accordance with a further aspect of the invention, customers that are logged into the account management center may be tracked to ascertain viewer habits, for the purpose of cross-marketing to those habits. Once this consumer data is captured, it can be used for the purpose of generating quality leads.

In accordance with an additional aspect of the present invention, when an affiliate customer places an order, a programmed continual outreach and cross-marketing program is put into motion via automated email. After approval of an account, affiliate customers are entered into an attraction program that focuses the affiliate customers on the benefits and rewards for program activity.

The system of the invention preferably is integrated with an ad tracking and quantifying platform to ensure substantially seamless ad campaign tracking and reporting. According to some embodiments of the invention, the platform is implemented as a database that tracks all advertisements and lead generation sources. Advantageously, the campaign tracking and quantifying platform facilitates building long-term behavior trends for consumer activity. The ad tracking and quantifying platform comprises an ad efficiency protocol designed to help determine the relative efficiency rates of a plurality of advertisements. The ad efficiency protocol is a mathematic model that may incorporate a variety of factors, including, but not limited to: (1) source of lead; (2) initial cost per lead; (3) effective cost per lead; (4) efficacy of advertising medium; (5) location of advertisement; and (6) time of advertisement.

The system and method of the invention are designed to attract motivated consumer borrowers and homeowners that seek household related services and financial products. Target consumer borrowers and homeowners include, but are not limited to: (1) consumers burdened by consumer debt and/or high interest rates; (2) consumers with poor credit or no credit; (3) consumers that cannot afford their current cost of living; (4) consumers in need of home improvement or other equity needs; (5) consumers shopping for better rates and payments; (6) consumers looking to close a transaction or secure a service provider quickly; (7) consumers resourcing for job or family; and (8) consumers frustrated with current level of service.

The system and method further designed to attract consumers that are going through life-changing events that necessitate an evaluation of finances. Such life-changing events may include having children, going to college, finding a new job, weddings, taxes, new cars, and planning for debt collection. Various methods of attracting such customers include, but are not limited to: (1) premium affiliates; (2) targeted advertising and syndication; (3) affinity/newsletter marketing; (4) repeat visitation; (5) cross-product promotion; and (6) survey of existing consumer base.

The system of the present invention may include a multi-tiered advertising program designed to establish a diverse and robust footprint for the customer's brand. Such advertising programs may be established in the following areas: (1) search engine optimization; (2) directory inclusion; (3) third party affiliate networks; (4) proprietary affiliate networks; (5) Adware networks; (6) ad networks; (7) publisher direct; (8) syndication; (9) third party email networks; (10) proprietary email; and/or (11) chat room/user group promotion.

Search engine optimization and directory inclusion may include long-term search engine marketing, contextual marketing, directory inclusion marketing and pay-for-performance marketing. Search engine optimization and directory inclusion are day-to-day programs that require constant monitoring to achieve maximum results. Key elements of these programs include, but are not limited to: (1) keyword science linguistics research; (2) organic search engine optimization; (3) pay per click management; (4) proper construction of section 508 HTML attributes; (5) hand coding of HTML; (6) link popularity integration; (7) submission order and sequence; (8) search engine partnering management; (9) web analytics and consumer business profiling; (10) text media buy advertising; (11) themed keyword saturation throughout the site; (12) confirmation of crawler friendly site navigation elements and site architecture; and (13) confirmation of crawler friendly site design elements and HTML attributes. Examples of third party affiliate networks include: www.affiliatefuel.com, www.befree.com; and www.cj.com.

The affiliate program of the invention is based on participation rules, fraud prevention, ongoing ad optimization and enticing, cost-effective payout programs. Continued participation in third party networks, B2B search engine optimization, online marketing, email marketing and guerilla marketing (e.g., chat rooms, message boards, etc.) are needed to increase the number of affiliate participants in the affiliate program.

It is important to maintain a knowledge base regarding the capabilities of each Adware network in terms of CPL range. By maintaining such a knowledge base, the expansion of existing buys in a properly arbitraged manner can be achieved. Suitable Adware network providers include, but are not limited to: (1) www.Claria.com; (2) www.WhenU.com; and (3) www.cydor.com.

It is also important to maintain a knowledge base regarding the capabilities of each ad network in terms of CPL range. The expansion of existing buys in a properly arbitraged manner can be achieved by maintaining such an ad network knowledge base. Suitable ad network providers include, but are not limited to: (1) www.247media.com; (2) www.Advertising.com; and (3) www.fastclick.com.

It is also important to maintain a knowledge base regarding the capabilities of each mainstream online publisher in terms of CPL range. Suitable publishers include: www.msn.com; www.yahoo.com; www.aol.com; www.espn.com; www.nascar.com; www.nfl.com; www.oxygen.com; www.weddingchannel.com; www.ivillage.com; www.bloomberg.com; www.forbes.com; cbs.marketwatch.com; and www.jsutlisted.com.

Suitable third party email networks include, but are not limited to: (1) www.InfoUSA.com; (2) www.whitelightventures.com; and (3) www.naviant.com. According to some embodiments of the invention, relationships that have been established with third party email networks are used to help establish a proprietary system for optimized open rates, click rates and decreased opt out rates.

Thus, it is seen that a system and method for capturing and consolidating lead using real time telephonic lead verification is provided. One skilled in the art will appreciate that the present invention can be practiced by other than the above-described embodiments, which are presented in this description for purposes of illustration and not of limitation. The description and examples set forth in this specification and associated drawings only set forth preferred embodiment(s) of the present invention. The specification and drawings are not intended to limit the exclusionary scope of this patent document. It is noted that various equivalents for the particular embodiments discussed in this description may practice the invention as well.

What is claimed is:

1. A method for capturing and consolidating a plurality of leads, comprising the steps of:
sourcing the plurality of leads;
capturing consumer data related to the leads;
consolidating the leads using a lead generation protocol; and
verifying the leads telephonically.

2. The method of claim 1, wherein the leads comprise potential consumer customers

3. The method of claim 1, wherein the step of sourcing the leads comprises deploying marketing tactics in the form of advertisements.

4. The method of claim 1, wherein the step of consolidating the leads using a lead generation protocol comprises the step of checking all consumer data for spurious or inconsistent data.

5. The method of claim 4, further comprising the step of purging consumer data that contains spurious or inconsistent data.

6. The method of claim 1, further comprising the step of returning the consumer data to the appropriate consumers for verification of the data.

7. The method of claim 1, wherein the leads are telephonically verified in real time.

8. A system for capturing and consolidating a plurality of leads, comprising of:
sourcing the plurality of leads, each lead comprising a potential consumer customer;
capturing consumer information related to the potential consumer customers;
consolidating the leads; and
verifying the leads telephonically in real time.

9. The method of claim 8, wherein the step of sourcing the leads comprises deploying marketing tactics in the form of advertisements.

10. The method of claim 8, wherein the step of consolidating the leads comprises the step of using a lead generation protocol to check all consumer information for spurious or inconsistent data.

11. The method of claim 10, further comprising the step of purging consumer information that contains spurious or inconsistent data.

12. The method of claim 8, further comprising the step of returning the consumer information to the appropriate consumers for verification of the data.

13. A system for capturing and consolidating a plurality of leads, comprising:
means for sourcing the plurality of leads;
a computer software program comprising machine readable instructions for capturing consumer data related to the plurality of leads and consolidating the leads using a lead generation protocol; and
means for verifying the leads telephonically.

14. The system of claim 13, wherein the leads comprise potential consumer customers.

15. The system of claim 13, wherein the means for sourcing the plurality of leads comprises deploying marketing tactics in the form of advertisements.

16. The system of claim 13, wherein the lead generation protocol is employed to check all consumer data for spurious or inconsistent data.

17. The system of claim 13, further comprising means for returning the consumer data to the appropriate consumers for verification of the data.

18. The system of claim 13, wherein the leads are telephonically verified in real time.
